(19) United States
(12) Patent Application Publication
(10) Pub. No.: US 2026/0337079 A1
(43) Pub. Date: Oct. 29, 2026

(54) MULTI-STAGE CIRCULAR AGRICULTURAL SYSTEM AND METHOD FOR SALINE-ALKALI LAND BASED ON MULTI-STAGE RESOURCE UTILIZATION OF SALINE-ALKALI WATER

(71) Applicant: Zhejiang University, Hangzhou (CN)

(72) Inventors: Weiren DONG, Hangzhou (CN); Miaoan SHU, Hangzhou (CN); Jiyong ZHOU, Hangzhou (CN); Yanmei ZHANG, Hangzhou (CN)

(21) Appl. No.: 19/697,661

(22) Filed: Jun. 4, 2026

(30) Foreign Application Priority Data
Jun. 11, 2025 (CN) 202510783645.5

(51) Int. Cl. C02F 9/00; C02F 1/00; C02F 1/44; C02F 1/52; C02F 1/66; C02F 101/10; C02F 103/00

(52) U.S. Cl. CPC C02F 9/00; C02F 1/001; C02F 1/441; C02F 1/5272; C02F 1/66; C02F 2101/10; C02F 2103/00; C02F 2201/009; C02F 2209/001; C02F 2209/055; C02F 2301/046; C02F 2307/00

(57) ABSTRACT

The present disclosure pertains to the field of comprehensive management of saline-alkali land and circular agriculture technology, and specifically to a multi-stage circular agricultural system and method for saline-alkali land based on multi-stage resource utilization of saline-alkali water, comprising a series of technical processes, including raised field reclamation, seawater-like regulation, reverse osmosis desalination, planting and breeding coupling, and tailwater recycling, so that the efficient circular utilization of natural resources in saline-alkali areas is achieved. The process primarily involves testing saline-alkali water from saline-alkali areas, extracting it for seawater-like regulation to obtain adjusted saline-alkali water, which is then desalinated through a reverse osmosis system to yield both fresh water and seawater-like water. These are used for crop cultivation and aquaculture, respectively, while the tailwater from aquaculture is recycled after solid-liquid separation.

### TECHNICAL FIELD

The present disclosure pertains to the field of comprehensive management of saline-alkali land and circular agriculture technology, particularly to a multi-stage circular agricultural system and method for saline-alkali land based on multi-stage resource utilization of saline-alkali water.

### BACKGROUND

Saline-alkali land is affected by natural and human factors, leading to the accumulation of excessive saline-alkali components on the soil surface layer. Such accumulation increases the saline-alkali concentration and osmotic pressure in the surface soil, causing a phenomenon of “physiological drought” in which crops struggle to absorb water, thereby affecting the growth of agricultural crops.

Existing saline-alkali land management employs physical, chemical, and biological measures, as well as combinations of the above three types of measures, to reduce the saline-alkali content in the soil, thereby converting saline-alkali land into cultivable land.

Physical engineering improvement methods: including open ditch drainage, shaft drainage, and pipe drainage. The open ditch drainage method exhibits high evaporation losses, and the open ditches occupy surface area, thereby reducing the effective cultivated land area. The pipe drainage has high installation costs, is susceptible to clogging, and incurs high maintenance costs. The shaft drainage merely transfers saline-alkali components from underground to the surface, and such components may return to groundwater via surface infiltration, resulting in secondary salinization, or underground saline-alkali water may be discharged into rivers, leading to an increase in the saline-alkali content of downstream soils and potentially transforming them into saline-alkali land.

Agronomic improvement methods: refer to the use of agronomic measures, such as applying soil from arable land, interlayering straw, and spreading sand, in saline-alkali land, particularly in areas with strong evaporation, to create a loose isolation layer within the soil. This interrupts soil capillary action, reduces upward migration of water and salts, alleviates soil compaction, decreases the degree of salinization on the soil surface layer, and improves soil structure. However, such methods are seasonally targeted and have limited effectiveness over time, failing to address the root cause related to groundwater level. Furthermore, the improvement effect on saline-alkali land varies depending on natural conditions.

Chemical improvement methods: primarily based on the principle of ion exchange, wherein ions in the soil are replaced by ions from an amendment. After the physical and chemical properties of the soil reach an ideal state, water is used for leaching to eliminate saline-alkali components. Chemical improvement measures offer advantages including rapid effects, flexible formulations, a wide selection of materials, and strong specificity. However, their effects are singular, the duration of effectiveness is short, the costs are high, and they are prone to causing secondary pollution to saline-alkali land. Additionally, leaching requires extensive water resources.

Biological improvement methods: involve planting new salt and alkali-tolerant varieties or utilizing microorganisms capable of directly growing in saline-alkali land to remove salt from roots or to alter the diversity of soil microbial communities, thereby improving soil quality and achieving ecological balance and long-term stability in saline-alkali land. Essentially, this approach involves screening salt and alkali-tolerant varieties suitable for cultivation in saline-alkali land, and ensuring that the varieties are appropriate for the soil conditions. For moderately and severely saline-alkali land, it remains difficult to plant major food crops such as rice, wheat, soybeans, and corn in the short term.

Comprehensive improvement methods: the prevailing view is that engineering improvement methods are primarily used for the improvement of moderately to severely saline-alkali land, biological and chemical improvement methods are primarily used for the improvement of lightly to moderately saline-alkali land, and agronomic improvement methods are particularly effective in areas with high evaporation. None of the above measures can fully remediate saline-alkali land when used separately; consequently, the integrated application of various improvement measures has gradually gained attention. For example, the integrated land use model of “raised field-shallow pool” suitable for coastal areas combines engineering improvement measures, such as digging soil to make ponds, piling up soil to construct raised fields, with biological improvement measures involving cultivation on the raised fields and aquaculture in the shallow pools. This method of raising land and digging ponds to lower the groundwater level is suitable for areas with high rainfall or access to external freshwater supplementation. It is not suitable for areas characterized by high evaporation, low rainfall, and no external freshwater supplementation. Specifically, the suitability of saline-alkali land improvement methods should be evaluated based on local hydrological conditions.

Additionally, many saline-alkali land improvement methods mainly rely on washing salinity by flood irrigation. Under such conditions, water-soluble salts migrate with water from higher elevations to lower elevations and accumulate in low-lying areas, thereby generating a large quantity of additional saline-alkali water. Low-lying saline-alkali soil is generally prone to waterlogging, exhibits high salt content, forms surface crusts, and has poor water infiltration, all of which severely impede the normal growth of crops.

In view of the foregoing, resources such as surface saline-alkali water collected from saline-alkali land and alkali drainage ditches have not been effectively utilized. Given the limitations of the above-described methods for the effective utilization of saline-alkali land and saline-alkali water, there is an urgent need for a novel circular agricultural system and method for saline-alkali land and/or saline-alkali water to enable efficient utilization of natural resources in saline-alkali areas and to enhance the comprehensive production capacity of saline-alkali land/water fisheries and agriculture.

### SUMMARY

An objective of the present disclosure is to provide a multi-stage circular agricultural system and method for saline-alkali land based on multi-stage resource utilization of saline-alkali water. The whole system is self-contained and does not require an external supply of fresh water.

Based on the multi-stage resource utilization of saline-alkali water, a multi-stage circular agricultural system for saline-alkali land with advantageous economic benefits is formed, thereby achieving a win-win scenario among ecological benefits, social benefits, and economic benefits, achieving green and sustainable development, and providing universal applicability for the comprehensive development and utilization of saline-alkali land.

In order to achieve the above objective, the present disclosure provides a multi-stage circular agricultural method for saline-alkali land based on multi-stage resource utilization of saline-alkali water, which includes the following steps:
step S1, after detecting saline-alkali water in a saline-alkali area, extracting the saline-alkali water for seawater-like regulation, that is, adjusting ion composition and proportion of the saline-alkali water according to the requirements of aquaculture water for aquatic products, and obtaining adjusted saline-alkali water;
step S2, desalinating the adjusted saline-alkali water through a first-stage reverse osmosis system to obtain fresh water and seawater-like water;
the seawater-like water refers to the associated concentrated saline-alkali water generated from the desalination treatment of the adjusted saline-alkali water, wherein the main ion composition and content within the saline-alkali water body are comparable to those of seawater of same salinity, making it suitable for use as aquaculture water;
step S3, employing the obtained fresh water for planting and freshwater aquaculture, and employing the obtained seawater-like water for aquaculture; and
step S4: after harvesting aquatic products, performing a solid-liquid separation on aquaculture tailwater, utilizing the filtered residue as fertilizer for crop planting, and discharging filtered tailwater into an outer pond or recycling it for aquaculture.

In some embodiments, a raised field reclamation is performed in a saline-alkali area before performing the seawater-like regulation.

In some embodiments, a distance between the surface soil and the groundwater level is 2.5-5 m, the distance can block the formation of soil capillary and avoid repeated salinization.

In some embodiments, in step S1, the outer pond generated after the raised field reclamation is used for aquaculture ponds/greenhouses, reservoir water storage, or storage of aquaculture tailwater.

In some embodiments, in step S1, the saline-alkali water is regulated by a seawater-like regulation method to obtain the regulated saline-alkali water, including the following two situations:
situation 1: when a calcium hardness of the extracted saline-alkali water is greater than that of the aquaculture water for aquatic products, a calcium ion concentration to be removed is determined based on an original calcium ion concentration of the saline-alkali water and concentrations of calcium ions, potassium ions, and magnesium ions in the intended aquaculture water after adjustment, then, calcium ions are removed, while potassium ions and magnesium ions are supplemented;
a method for removing calcium ion concentration is: adding potassium oxalate or sodium oxalate to the water to precipitate calcium ions;
situation 2: when the calcium hardness of the extracted saline-alkali water is less than that of the aquaculture water for aquatic products, calcium ions, potassium ions, and magnesium ions are supplemented to the saline-alkali water based on concentrations of calcium ions, potassium ions, and magnesium ions in the intended aquaculture water after adjustment.

In some embodiments, in step S2, a freshwater yield obtained by the reverse osmosis system is 45-50%.

In some embodiments, in step S2, a salinity of aquaculture water for aquatic products obtained by the reverse osmosis system is less than or equal to 35‰.

In some embodiments, in step S3, when a quantity of seawater-like water meets requirements for aquaculture, the remaining saline-alkali water is directly subjected to a desalination treatment without undergoing seawater-like regulation, and the resulting concentrated saline-alkali water is directly recharged to a bottom of the saline-alkali water layer.

The present disclosure further provides a multi-stage circular agricultural system for saline-alkali land based on multi-stage resource utilization of saline-alkali water, including: a seawater-like regulation module, configured to adjust saline-alkali water into saline-alkali water having an ion composition and content similar to or consistent with that of both aquaculture water and seawater of the same salinity;
a saline-alkali water desalination module, configured to desalinate the adjusted saline-alkali water through a reverse osmosis system, thereby obtaining fresh water and seawater-like water simultaneously;
a planting module including a drip irrigation system under mulch;
an aquaculture module, configured for the aquaculture of aquatic products;
a raised field module, configured to increase a distance between the surface soil and the groundwater level, and to form an outer pond and/or reservoir; and
a photovoltaic power generation module, configured to supply power to the seawater-like regulation module, the saline-alkali water desalination module, the planting module, and the aquaculture module.

Therefore, the present disclosure adopts the above-mentioned multi-stage circular agricultural system and method for saline-alkali land based on multi-stage resource utilization of saline-alkali water. The beneficial technical effects are as follows:

(1) Raised field reclamation achieves multiple benefits at once. On one hand, by raising the surface height to adjust the relative height between the surface layer and the groundwater level, the problem of land salinization is addressed at its source, and repeated salinization is avoided. On the other hand, the earthwork supply area provides a site for aquaculture, eliminating the need for separately digging a pond. In the third aspect, the excavated pond is also utilized as a reservoir for water storage. When a large amount of fresh water is generated, the fresh water is collected into the fresh water reservoir, thereby creating fresh water reserves for subsequent applications.

(2) Through seawater-like regulation technology, a calculated amount of calcium salt remover or the ions required for the water body is added in advance, so that the concentration of calcium ions in the water is regulated, and the hardness of the water is precisely adjusted. Additionally, the reverse osmosis system is protected from fouling due to the precipitation of high concentrations of calcium salts in the saline-alkali water during the desalination process.

(3) The reverse osmosis system achieves a fresh water yield of 45%-50%, which avoids fouling of the reverse osmosis membrane due to salt precipitation, and converts the adjusted saline-alkali water into seawater-like water. This differs from the freshwater yield of industrial wastewater desalination, which has a yield of 65%-85%. The method employed in the present disclosure is not affected by the fouling of reverse osmosis membranes caused by the saturated precipitation of salts in the water. Furthermore, conventional reverse osmosis systems used for desalination of saline-alkali water/seawater, which typically require a two-stage reverse osmosis system (i.e., reverse osmosis treatment is performed again on the produced water from the first reverse osmosis stage) to obtain high-purity fresh water. Similarly, to enhance the total fresh water yield, a reverse osmosis concentrate reflux process is employed, by which secondary reverse osmosis treatment is performed on concentrated saline-alkali water to obtain fresh water and higher-concentration saline-alkali water. Accordingly, the method employed by the present disclosure is low-cost and imposes fewer requirements or constraints on equipment.

(4) Multi-stage resource utilization of saline-alkali water includes the following: \textcircled{1} The saline-alkali water obtained after seawater-like regulation is directly employed for aquaculture, and the unused saline-alkali water resources are converted into aquaculture water, yielding economic benefits. \textcircled{2} The adjusted saline-alkali water obtained via seawater-like regulation is subjected to desalination treatment using a reverse osmosis system, and the obtained fresh water is utilized for crop cultivation or is reused for crop cultivation following freshwater aquaculture. \textcircled{3} The regulated saline-alkali water is treated by the reverse osmosis system to obtain seawater-like water for high-value aquaculture, which provides favorable economic benefits (compared with conventional planting industries, the output value of seafood produced via seawater-like aquaculture is increased by more than 100 times), thereby rendering the entire circular agriculture system sustainable. \textcircled{4} Aquaculture is practiced as industrial recirculating aquaculture, and the quantity of aquaculture water used is far less than that of concentrated saline-alkali water. When the quantity of seawater-like water satisfies the requirements for aquaculture, the remaining saline-alkali water is directly subjected to desalination treatment without undergoing seawater-like regulation. The produced concentrated saline-alkali water is directly recharged to the bottom of the saline-alkali water layer, without contaminating the original saline-alkali water (the concentrated saline-alkali water is merely concentrated from saline-alkali water, and its composition is consistent with that of the original saline-alkali water). Following recharge, the underground or surface water level is maintained relatively stable, thereby preventing geological disasters such as ground subsidence caused by excessive extraction of underground saline-alkali water. \textcircled{5} The resulting seawater-like water is used for aquaculture, in which the organic matter, such as feces and residual bait in the aquaculture water, is collected via conventional solid-liquid separation technology, and is applied to crops as fertilizer. The filtered aquaculture tailwater, which is saline-alkali water, is either recycled for aquaculture or discharged into the outer pond. Stability of the original saline-alkali water level is achieved by balancing water evaporation of the surface, the quantity of saline-alkali water recharge, outer pond evaporation, and the quantity of groundwater supplemented into the outer pond.

(5) The desalination of saline-alkali water consumes a significant amount of energy, and the resulting fresh water brings with it high production costs. When this water is used for open-field crop cultivation, the income from planting is often lower than the costs involved, resulting in a state of economic loss. This is a key factor in explaining why the strategy of planting after desalination of saline-alkali water has not been widely adopted. Secondly, the discharge of concentrated saline-alkali water generated from saline-alkali water desalination causes environmental pollution. The above two objective drawbacks hinder the popularization and application of a single saline-alkali water desalination technology in saline-alkali areas.

Moreover, the direct use of saline-alkali water for aquaculture is limited by the significant deviation between the major ion composition of saline-alkali water and that of seawater. Saline-alkali water is not suitable for direct use in the aquaculture of high-value seafood. Furthermore, saline-alkali water aquaculture and saline-alkali land crop cultivation cannot be coupled, so the saline-alkali land cannot be reclaimed into arable land. The method employed in the present disclosure creatively and synergistically integrates modules such as seawater-like regulation, saline-alkali water desalination, raised field, planting, aquaculture, and photovoltaics to form a circular agricultural system with favourable economic benefits, thereby achieving unexpected results.

### BRIEF DESCRIPTION OF THE DRAWINGS

FIG. 1 is a flow chart of a multi-stage circular agricultural method for saline-alkali land based on multi-stage resource utilization of saline-alkali water;

FIG. 2 is a structural diagram of a multi-stage circular agricultural system for saline-alkali land based on multi-stage resource utilization of saline-alkali water;

### DETAILED DESCRIPTION

The technical scheme of the present disclosure is further explained below by drawings and embodiments.

Unless otherwise defined, the technical or scientific terms used in the present disclosure shall be those to which the present disclosure belongs.

### Embodiment 1

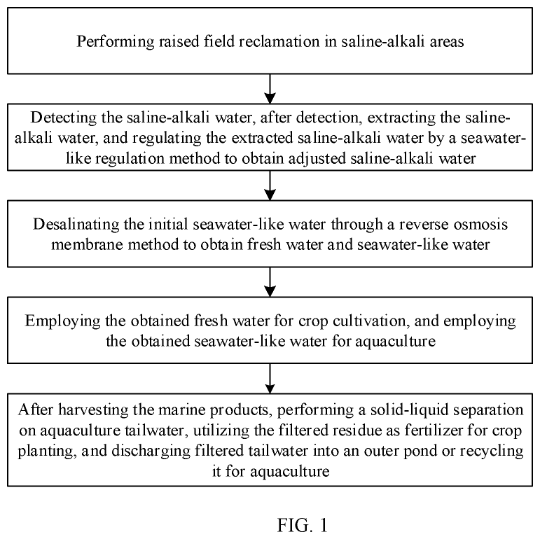

As shown in FIG. 1, a flow chart of a multi-stage circular agricultural method for saline-alkali land based on multi-stage resource utilization of saline-alkali water according to the present disclosure, including the following steps:

Step S1, raised field reclamation.

Specifically, when evaporation in the saline-alkali area is not high, it is considered to excavate ponds in raised fields, while simultaneously lowering the groundwater level through shaft drainage. When evaporation is high, only the raised field should be considered, with open-air aquaculture ponds excluded. The distance between the surface soil and the groundwater level is increased, so that the formation of soil capillary action is effectively prevented and soil salinization is avoided. The distance between the surface soil and the groundwater level is is preferably maintained at 2.5-5 m.

Earthwork is supplied through pond excavation, and ponds are excavated locally to avoid or reduce transportation costs. The earthwork generated from pond excavation is used for raised field reclamation, and the excavated foundation or pond opening is employed as an industrial aquaculture facility for aquatic products, or as a reservoir for water storage, or as an outer pond for storing aquaculture tailwater.

In the present disclosure, the raised field reclamation achieves multiple benefits at once. On one hand, by increasing and regulating the distance between the surface soil and the groundwater level, the problem of land salinization is addressed at its source. On the other hand, a level site is provided for aquaculture. In a third aspect, the excavated pond is also utilized to construct a freshwater reservoir for storing fresh water. When the fresh water produced by desalination of saline-alkali water is in surplus, the fresh water is directed into the reservoir for storage and is reserved for subsequent fresh water applications.

For groundwater level control, shaft drainage is utilized. If the groundwater level is too high, saline-alkali water is extracted and treated with a reverse osmosis system (as described in step S3 below) to produce additional fresh water, thereby accelerating the rate of saline-alkali reclamation.

Step S2, seawater-like regulation.

Before seawater-like regulation is performed, the saline-alkali water should be tested first, with the detection indices primarily including the major ions in the saline-alkali water. The saline-alkali water in the present disclosure is either surface saline-alkali water or underground saline-alkali water.

In the present disclosure, the objective of regulating saline-alkali water and detecting its salinity is to determine the optimal aquaculture species based on the actual salinity of the saline-alkali water. According to actual detection conditions, a field test is conducted in a certain area of Xinjiang, and the salinity range of the saline-alkali water is determined to be approximately 3‰-18‰.

An objective of detecting ions in the saline-alkali water is to regulate the composition and proportion of ions in the saline-alkali water according to the detected ion composition, and then to compare it with seawater of the same salinity based on the existing ion composition, so that ions are supplemented or removed accordingly.

Specifically, seawater-like regulation includes the following two situations:
1) when the calcium hardness of the extracted saline-alkali water is greater than that of the aquaculture water for aquatic products, the calcium ion concentration to be removed is determined based on the original calcium ion concentration of the water body and concentrations of calcium ions, potassium ions, and magnesium ions in the intended aquaculture water after adjustment, then, potassium ions and magnesium ions are supplemented;
the method for removing calcium ion concentration is: adding potassium oxalate or sodium oxalate to the water to precipitate calcium ions;
2) when the calcium hardness of the extracted saline-alkali water is less than that of the aquaculture water for aquatic products, the concentration of calcium ion, magnesium ion and potassium ion to be supplemented is calculated according to the concentration of calcium ion, magnesium ion and potassium ion in the aquaculture water to be adjusted.

After the above regulation steps, seawater-like water having an ion composition similar to that of seawater of the same salinity is obtained. Additionally, the hardness of the water body is adjusted, and the precipitation of calcium salt is reduced in the subsequent reverse osmosis membrane desalination, so as to prevent the occurrence of reverse osmosis membrane fouling.

Some specific regulation examples are given below.

### 1) Oxalate Precipitation of Calcium Ions in High-Hardness Saline-Alkali Water

1. Oxalic acid, sodium oxalate, and potassium oxalate solutions are prepared as follows: (1) 19.80 g of H₂C₂O₄ is dissolved in 900 mL of water, and then diluted to 1000 mL, and the oxalic acid solution with a concentration of 19.80 g/L (220 mmol/L) is obtained after mixing. (2) 29.48 g of Na₂C₂O₄ is dissolved in 900 mL of water, and then diluted to 1000 mL, and the sodium oxalate solution with a concentration of 29.48 g/L (220 mmol/L) is obtained after mixing. (3) 22.10 g of K₂C₂O₄·H₂O is dissolved in 900 mL of water, and then diluted to 1000 mL, and the potassium oxalate solution with a concentration of 120 mmol/L is obtained after mixing.

2. The salinity of underground saline-alkali water from Area B is approximately 9‰, and the concentrations of Na⁺, K⁺, Ca²⁺, Mg²⁺, Cl⁻, and SO4²⁻ in the water are 2277.0 mg/L, 43.6 mg/L, 441.2 mg/L, 212.6 mg/L, 2963.8 mg/L, and 2211.6 mg/L, respectively. The corresponding concentrations of Na⁺, K⁺, Ca²⁺, Mg²⁺, Cl⁻, and SO4²⁻ in 9‰ seawater are 2771.5 mg/L, 99.5 mg/L, 108.3 mg/L, 332.5 mg/L, 4990.0 mg/L, and 696.8 mg/L, respectively. It is observed that, for the four main cations, compared with seawater of the same salinity, the 9‰ saline-alkali water is deficient in K⁺ and Mg²⁺, while Ca²⁺ is four times that of seawater of the same salinity. The composition and proportion of ions are significantly different from those of seawater. In order to use saline-alkali water for mariculture, the saline-alkali water is required to be regulated into seawater-like water.

3. Three 2 L beakers are selected, and 1000 mL of underground saline-alkali water from Area B is added to each beaker. Subsequently, 10 mL of oxalic acid, sodium oxalate, and potassium oxalate solutions are added to the saline-alkali water, respectively. The results show that in the sodium oxalate and potassium oxalate groups, white suspended matter immediately appears upon addition of the solution. After mixing, white suspended matter is observed throughout the water body. After standing overnight, white precipitate is accumulated at the bottom of the beaker, and the water body changes from white turbidity to transparency. The results of inductively coupled plasma mass spectrometry (ICP-MS) indicate that oxalate treatment precipitates equimolar amounts of Ca²⁺. After treatment with sodium oxalate, Ca²⁺ ions in the saline-alkali water are reduced by nearly 88.0 mg/L (2.2 mmol/L), while the concentrations of Mg²⁺ and K⁺ remain unchanged. After treatment with potassium oxalate, the concentration of Ca²⁺ in the water is reduced by nearly 48.0 mg/L (1.2 mmol/L), the concentration of Mg²⁺ remains unchanged, and the concentration of K⁺ is increased by nearly 93.6 mg/L (2.4 mmol/L). It is demonstrated that sodium oxalate accurately reduces calcium hardness in saline-alkali water without affecting magnesium hardness. Potassium oxalate not only accurately reduces calcium hardness in saline-alkali water without affecting magnesium hardness, but also accurately increases the concentration of K⁺. The situation in the oxalic acid group is completely different. With the addition of oxalic acid solution, no white suspended matter appears in the saline-alkali water. Even when the amount of oxalic acid is increased by 10 times, no white suspended matter is formed. It is shown that oxalate (sodium oxalate and potassium oxalate) accurately precipitate Ca²⁺ in water, whereas oxalic acid does not have this function.

### 2) Regulation of Calcium Hardness and Potassium Ion Concentration of High Hardness Saline-Alkali Water by Potassium Oxalate and Sodium Oxalate Solutions

1. Sodium oxalate and potassium oxalate solutions are prepared as follows: (1) 30.55 g of Na₂C₂O₄ is dissolved in 900 mL of water, and then diluted to 1000 mL, and the sodium oxalate solution with a concentration of 30.55 g/L (228 mmol/L) is obtained after mixing. (2) 53.05 g of K₂C₂O₄·H₂O is dissolved in 900 mL of water, and then diluted to 1000 mL, and the potassium oxalate solution with a concentration of 288 mmol/L is obtained after mixing. (3) 334 mL of the above-prepared sodium oxalate solution is taken, and then 25 mL of the above-prepared potassium oxalate solution is added, and the mixture is mixed well to obtain a potassium oxalate/sodium oxalate mixed solution.

2. Three 2 L beakers are selected, and 1000 mL of underground saline-alkali water from Area B is added to each beaker, which are labeled #1, #2, and #3. For sample #1, 2.5 mL of potassium oxalate solution is added first. It is observed that upon the addition of the solution, white suspended matter immediately appears in the water body. After mixing, white suspended matter is present throughout the water body. After 33.4 mL of sodium oxalate solution is added, additional white precipitate is observed in the saline-alkali water. After standing overnight or after the precipitate is filtered, saline-alkali water with reduced calcium and increased potassium is obtained. For sample #2, 33.4 mL of sodium oxalate solution is added first. It is observed that upon the addition of the solution, a large amount of white suspended matter immediately appears in the water body. After mixing, white suspended matter is present throughout the water body. After 2.5 mL of potassium oxalate solution is added, additional white precipitate is still generated in the saline-alkali water. After standing overnight or after the precipitate is filtered, saline-alkali water with reduced calcium and increased potassium is obtained. For sample #3, 35.9 mL of the potassium oxalate/sodium oxalate mixed solution is added. It is observed that upon the addition of the solution, a large amount of white suspended matter immediately appears in the water body. After mixing, the solution is allowed to stand overnight or is filtered to remove the precipitate, so that the saline-alkali water with reduced calcium and increased potassium is obtained. After detection by ICP-MS, it is found that the concentrations of Na⁺, K⁺, Ca²⁺, and Mg²⁺ in the saline-alkali water with reduced calcium and increased potassium obtained after treatment of samples #1, #2, and #3 are 2536.2 mg/L, 96.3 mg/L, 104.1 mg/L, and 205.2 mg/L, respectively. It is demonstrated that the sequential addition of potassium oxalate solution and sodium oxalate solution to the saline-alkali water, or the simultaneous addition of both, does not affect the outcome of water quality regulation. Both methods show that the concentration of Ca²⁺ is accurately reduced, the concentration of K⁺ is accurately increased, and neither affects the concentration of Mg²⁺. When the potassium oxalate/sodium oxalate mixed solution is added to the saline-alkali water, the two purposes of accurate calcium reduction and potassium increase are achieved in a single operation, and the process is straightforward. Additionally, oxalate ions are detected by ion chromatography, and it is found that the concentration of oxalate ions is less than 10 mg/L, which is less than 1.5% of the original concentration, indicating that calcium oxalate precipitation is complete and oxalate ion residue is minimal.

3) Seawater-Like Regulation Method for Saline-Alkali Water Seawater-Like Regulation Method for Saline-Alkali Water Dominated by K⁺, Ca²⁺ and Mg²⁺

1. Preparation of sodium oxalate, potassium oxalate, and magnesium chloride solution: (1) 30.55 g of Na₂C₂O₄ is dissolved in 900 mL of water, and then diluted to 1000 mL, and the sodium oxalate solution with a concentration of 30.55 g/L (228 mmol/L) is obtained after mixing. (2) 53.05 g of K₂C₂O₄·H₂O is dissolved in 900 mL of water, and then diluted to 1000 mL, and the potassium oxalate solution with a concentration of 288 mmol/L is obtained after mixing. (3) 334 mL of the above-prepared sodium oxalate solution is taken, and then 25 mL of the above-prepared potassium oxalate solution is added, and the mixture is mixed well to obtain a potassium oxalate/sodium oxalate mixed solution. (4) 304.95 g of MgCl₂·6H₂O is dissolved in 900 mL of water, and then diluted to 1000 mL, and the magnesium chloride solution with a concentration of 1500 mmol/L is obtained after mixing.

2. Three 2 L beakers are selected, and 1000 mL of underground saline-alkali water from Area B is added to each beaker, which are labeled #1, #2, and #3. For sample #1, 2.5 mL of potassium oxalate solution is added first. It is observed that upon the addition of the solution, white suspended matter immediately appears in the water body. After mixing, white suspended matter is present throughout the water body. After 33.4 mL of sodium oxalate solution is added, additional white precipitate is observed. After standing overnight or after the precipitate is filtered, 3.5 mL of magnesium chloride solution is added to the clear solution, so that the saline-alkali water with reduced calcium and increased potassium and magnesium is obtained. For sample #2, 33.4 mL of sodium oxalate solution is added first. It is observed that upon the addition of the solution, a large amount of white suspended matter immediately appears in the water body. After mixing, white suspended matter is present throughout the water body. After 2.5 mL of potassium oxalate solution is added, white precipitate continues to be formed. After standing overnight or after the precipitate is filtered, 3.5 mL of magnesium chloride solution is added to the clear solution, so that the saline-alkali water with reduced calcium and increased potassium and magnesium is obtained. For sample #3, 35.9 mL of potassium oxalate/sodium oxalate mixed solution is added. It is observed that upon the addition of the solution, a large amount of white suspended matter immediately appears in the water body. After mixing, the solution is allowed to stand overnight or is filtered to remove the precipitate. Then, 3.5 mL of magnesium chloride solution is added to the clear solution, so that the saline-alkali water with reduced calcium and increased potassium and magnesium is obtained. After detection by ICP-MS, the concentrations of Na⁺, K⁺, Ca²⁺, and Mg²⁺ in the saline-alkali water with reduced calcium and increased potassium and magnesium obtained after treatment of samples #1, #2, and #3 are approximately 2527.7 mg/L, 96.0 mg/L, 103.7 mg/L, and 325.8 mg/L, respectively. Except for Na⁺, the concentrations of the other three cations are substantially consistent with the ion concentrations corresponding to 9% o seawater, thereby achieving regulation of saline-alkali water to the levels of K⁺, Ca²⁺, and Mg⁺.

3. Amplification system: the adjusted saline-alkali water, in which the concentrations of K⁺, Ca²⁺, and Mg²⁺ correspond to those of seawater with a salinity of 9% o, is prepared and used for aquaculture of Litopenaeus vannamei in southern Xinjiang. Except that the used aquaculture water is the adjusted saline-alkali water, all other operations are consistent with those described in “Industrial Aquaculture Technology of Litopenaeus vannamei” (Shi Chaobin, Sun Yanhui. Henan Fisheries, 2023(2): 14-15, 20). The results show that although the Na⁺ concentration of the adjusted saline-alkali water is not completely consistent with that of seawater with a salinity of 9‰, being 91.5% of the Na⁺ concentration in seawater of the same salinity, normal cultivation of Litopenaeus vannamei is still achieved. This indicates that when the concentrations of Na⁺, K⁺, Ca²⁺, and Mg²⁺ in the adjusted saline-alkali water are approximately equivalent to the corresponding ion concentrations in seawater of the same salinity, a successful cultivation of Litopenaeus vannamei is achieved, and the adjusted saline-alkali water may be used as aquaculture water for Litopenaeus vannamei. After 60 days of feeding and management, no disease occurs throughout the cultivation process. The size of Litopenaeus vannamei reaches 70-80 pieces/kg, the yield per mu is 3000 kg, and the output value per mu for a single crop exceeds 180,000 yuan (mu: Chinese unit of land measurement that is commonly 666.7 square meters).

4. Amplification system: the adjusted saline-alkali water, in which the concentrations of K⁺, Ca²⁺, and Mg²⁺ correspond to those of seawater with a salinity of 9‰, is prepared and used for aquaculture of pearl gentian grouper in southern Xinjiang. Except that the used aquaculture water is the adjusted saline-alkali water with a depth of 1.2 m and the fry stocking specification is 100 g, all other operations are consistent with those described in “Experimental Study on Industrial Aquaculture Technology for Gentian Grouper” (Tian Lili et al. Fishery Guide to be Rich, 2023 (11): 50-52). The results show that the adjusted saline-alkali water is suitable for use as aquaculture water for the pearl gentian grouper. After 5 months of feeding and management, the size of pearl gentian grouper reaches 500-900 g/fish, corresponding to an output value of 500,000 yuan per mu.

4) Seawater-Like Regulation Method for Saline-Alkali Water Based on Na⁺, K⁺, Ca²⁺, and Mg^{2+.}

1. Sodium oxalate, potassium oxalate, magnesium chloride, and sodium chloride solutions are prepared as follows: (1) 30.55 g of Na₂C₂O₄ is dissolved in 900 mL of water, and then diluted to 1000 mL, and the sodium oxalate solution with a concentration of 30.55 g/L (228 mmol/L) is obtained after mixing. (2) 53.05 g of K₂C₂O₄·H₂O is dissolved in 900 mL of water, and then diluted to 1000 mL, and the potassium oxalate solution with a concentration of 288 mmol/L is obtained after mixing. (3) 334 mL of the above-prepared sodium oxalate solution is taken, and then 25 mL of the above-prepared potassium oxalate solution is added, and the mixture is mixed well to obtain a potassium oxalate/sodium oxalate mixed solution. (4) 304.95 g of MgCl₂ 6H₂O is dissolved in 900 mL of water, and then diluted to 1000 mL, and the magnesium chloride solution with a concentration of 1500 mmol/L is obtained after mixing. (5) 360 g of NaCl is dissolved in 900 mL of water, and then diluted to 1000 mL, and the sodium chloride solution with a concentration of 360 g/L (6160 mmol/L) is obtained after mixing. (6) 350 mL of the above-prepared magnesium chloride solution is taken, and then 130 mL of the above-prepared sodium chloride solution is added, and the mixture is mixed well to obtain a magnesium chloride/sodium chloride mixed solution.

2. Three 2 L beakers are selected, and 1000 mL of underground saline-alkali water from Area B is added to each beaker, which are labeled #1, #2, and #3. For sample #1, 35.9 mL of the potassium oxalate/sodium oxalate mixed solution is added. It is observed that upon the addition of the solution, a large amount of white suspended matter immediately appears in the water body. After mixing, the solution is allowed to stand overnight or is filtered to remove the precipitate. Then, 3.5 mL of magnesium chloride solution is added and mixed, followed by the addition of 1.3 mL of sodium chloride solution, and mixing is performed, and the seawater-like water with Na⁺, K⁺, Ca²⁺, and Mg²⁺ composition and proportion consistent with those of seawater of the same salinity is obtained. For sample #2, 35.9 mL of the potassium oxalate/sodium oxalate mixed solution is added. It is observed that upon the addition of the solution, a large amount of white suspended matter immediately appears in the water body. After mixing, the solution is allowed to stand overnight or is filtered to remove the precipitate. Then, 1.3 mL of sodium chloride solution is added and mixed, followed by the addition of 3.5 mL of magnesium chloride solution, and mixing is performed, and the seawater-like water with Na⁺, K⁺, Ca²⁺, and Mg²⁺ composition and proportion consistent with those of seawater of the same salinity is obtained. For sample #3, 35.9 mL of the potassium oxalate/sodium oxalate mixed solution is added. It is observed that upon the addition of the solution, a large amount of white suspended matter immediately appears in the water body. After mixing, the solution is allowed to stand overnight or is filtered to remove the precipitate. Then, 4.8 mL of the magnesium chloride/sodium chloride mixed solution is added and mixed, and the seawater-like water with Na⁺, K⁺, Ca²⁺, and Mg²⁺ composition and proportion consistent with those of seawater of the same salinity is obtained. After detection by ICP-MS, the concentrations of Na⁺, K⁺, Ca²⁺, and Mg²⁺ in the seawater-like water obtained after treatment of samples #1, #2, and #3 are found to be approximately 2701.5 mg/L, 96.0 mg/L, 103.6 mg/L, and 325.4 mg/L, respectively. The concentrations of the four cations are substantially consistent with the ion concentrations corresponding to 9% seawater, indicating that the saline-alkali water is regulated into seawater-like water having Na⁺, K⁺, Ca²⁺, and Mg²⁺ concentrations and proportions consistent with those of seawater of the same salinity.

3. Amplification system: the adjusted saline-alkali water, in which the concentrations of K⁺, Ca²⁺, and Mg²⁺ correspond to those of seawater with a salinity of 9‰, is prepared and used for aquaculture of Litopenaeus vannamei in southern Xinjiang. Except that the used aquaculture water is the adjusted saline-alkali water, all other operations are consistent with those described in “Industrial Aquaculture Technology of Litopenaeus vannamei” (Shi Chaobin, Sun Yanhui. Henan Fisheries, 2023(2): 14-15, 20). The results show that normal cultivation of Litopenaeus vannamei is achieved by accurately regulating the saline-alkali water into water having Na⁺, K⁺, Ca²⁺, and Mg²⁺ concentrations corresponding to those of seawater of the same salinity. The regulated saline-alkali water may be used as aquaculture water for Litopenaeus vannamei. After 60 days of feeding and management, no disease occurs throughout the cultivation process. The size of the shrimp reaches 70-80 pieces/kg, the yield per mu is 3200 kg, and the output value per mu for a single crop exceeds 190,000 yuan.

Step S3, reverse osmosis system desalination of saline-alkali water.

The saline-alkali water desalinated by the reverse osmosis system in the present disclosure is a regulated saline-alkali water obtained by the regulation in step S2. Its purpose is to obtain fresh water required for crop planting and seawater for marine aquaculture at the same time, without considering the high yield of fresh water. The fresh water yield in the present disclosure is controlled at 45%-50%. This differs from the conventional purification of industrial saline-alkali water, the fresh water yield purified by conventional industrial saline-alkali water is 65%-85%.

Furthermore, conventional reverse osmosis systems used for desalination of saline-alkali water typically require a two-stage reverse osmosis system (i.e., reverse osmosis treatment is performed again on the produced water from the first reverse osmosis stage) to obtain high-purity fresh water. Similarly, to enhance the total fresh water yield, a reverse osmosis concentrate reflux process is employed, by which secondary reverse osmosis treatment is performed on concentrated saline-alkali water to obtain fresh water and higher-concentration saline-alkali water.

In this present disclosure, only a one-stage reverse osmosis system is employed, and the fresh water yield is controlled at 45%-50%, such that the salinity of the concentrated saline-alkali water is in the range of 6‰-35‰, making it suitable for aquaculture of marine species. Moreover, when the fresh water yield is controlled at 45%-50%, salt precipitation does not occur in the saline-alkali water, and fouling of the reverse osmosis membrane is avoided.

Therefore, by combining the seawater-like regulation of step S2 with the novel reverse osmosis strategy of step S3, the problem of reverse osmosis membrane fouling during reverse osmosis desalination of saline-alkali water is solved.

Experiments are performed in two areas of the First Division of the Xinjiang Production and Construction Corps. The major ion compositions of the water bodies in Area A and Area B are shown in Table 1.

TABLE 1
Major ion composition and concentration indices of saline-
alkali water in two areas (concentration unit: mg/L)

| | Na⁺ | K⁺ | Ca²⁺ | Mg²⁺ | Cl⁻ | SO₄²⁻ | Salinity ‰ |
|---|---|---|---|---|---|---|---|
| Area A | 4612.6 | 52.2 | 409.9 | 274.7 | 5647.1 | 3334.8 | 15.3 |
| Area B | 2198.5 | 43 | 418.3 | 213.2 | 2906.8 | 2105.3 | 8.9 |

The salinity of underground saline-alkali water in Area A is 15.3‰, and the major ion composition is shown in Table 1. When the saline-alkali water is concentrated to 2 times its original volume, i.e., when the salinity reaches 30.6‰, no salt precipitation is observed. When the saline-alkali water is concentrated to 2.5 times its original volume, the salinity reaches 38.3‰, and still no salt precipitation is observed. When the saline-alkali water is concentrated to 3.3 times its original volume, the salinity reaches 50.9‰, and fine crystals are precipitated.

The salinity of underground saline-alkali water in Area B is 8.9‰, and the major ion composition is shown in Table 1. When the saline-alkali water is concentrated to 2 times its original volume, i.e., when the salinity reaches 17.8‰, no salt precipitation is observed. When the saline-alkali water is concentrated to 3 times its original volume, the salinity reaches 26.7‰, and still no salt precipitation is observed. When the saline-alkali water is concentrated to 4 times its original volume, the salinity reaches 35.6‰, and still no salt precipitation is observed. When the saline-alkali water is concentrated to 5 times its original volume, the salinity reaches 44.5‰, and slender crystals are precipitated.

The major ion composition and concentration indices of the water body after desalination of saline-alkali water from Area B are shown in Table 2.

TABLE 2
Major ion composition and concentration indices of saline-alkali water
before and after desalination in Area B (concentration unit: mg/L)

| | Na⁺ | K⁺ | Ca²⁺ | Mg²⁺ | Cl⁻ | SO4²⁻ | Salinity ‰/TDS |
|---|---|---|---|---|---|---|---|
| Saline-alkali water from Area B | 2277.0 | 43.6 | 441.2 | 212.6 | 2963.8 | 2211.6 | 8.9 |
| Regulated saline-alkali water | 2700.8 | 96.0 | 103.6 | 325.4 | 3450.0 | 2111.6 | 9.1 |
| 9‰ seawater | 2771.5 | 99.5 | 108.3 | 332.5 | 4990.0 | 696.8 | 9.0 |
| Reverse osmosis permeate | 170.4 | 0.0 | 0.0 | 0.0 | 238.3 | 0.0 | 0.4 |
| Seawater-like water | 5472.3 | 195.5 | 211.9 | 657.9 | 6990.0 | 4330.0 | 17.9 |
| 18‰ seawater | 5543.0 | 199.0 | 216.6 | 665.0 | 9980.0 | 1393.6 | 18.0 |

Step S4, crop planting and aquaculture for aquatic products.

In the present disclosure, the fresh water obtained from the reverse osmosis system is used for crop planting or domestic water. During the non-irrigation period, when crop water demand is low, the excess fresh water is directed into the reservoir obtained in step S1 for fresh water storage. When irrigation is required, pumping irrigation is performed. The seawater-like water obtained from the reverse osmosis system is used for industrial recirculating aquaculture of aquatic products. Due to the water demand for recirculating aquaculture being small, the concentrated saline-alkali water generated over a long period exceeds the seawater-like water demand for marine aquaculture. At this time, when the quantity of seawater-like water meets the requirements for aquaculture, the remaining saline-alkali water is directly subjected to desalination treatment without undergoing seawater-like regulation, and the resulting concentrated saline-alkali water is directly recharged to the bottom of the saline-alkali water layer, without polluting the original saline-alkali water. Furthermore, it contributes to the relative stability of underground or surface water levels and prevents geological disasters such as ground collapse.

The above-described seawater-like water is prepared and used for the aquaculture of Litopenaeus vannamei in southern Xinjiang. Except that the used aquaculture water is the adjusted saline-alkali water, all other operations are consistent with those described in “Industrial Aquaculture Technology of Litopenaeus vannamei” (Shi Chaobin, Sun Yanhui. Henan Fisheries, 2023(2): 14-15, 20). The results show that normal cultivation of Litopenaeus vannamei is achieved using seawater-like water, indicating that the seawater-like water may be used as aquaculture water for Litopenaeus vannamei. After 60 days of feeding and management, no disease occurs throughout the cultivation process. The size of the shrimp reaches 60-70 pieces/kg, the yield per mu is 3700 kg, and the output value per mu for a single crop exceeds 220,000 yuan.

The above-described seawater-like water is prepared and used for the aquaculture of pearl gentian grouper in southern Xinjiang. Except that the used aquaculture water is the seawater-like water at a depth of 1.2 m and the fry stocking specification is 100 g, all other operations are consistent with those described in “Experimental Study on Industrial Aquaculture Technology for Gentian Grouper” (Tian Lili et al. Fishery Guide to be Rich, 2023 (11): 50-52). The results show that after 5 months of feeding and management, the size of pearl gentian grouper reaches 550-950 g/fish, corresponding to an output value of more than 530,000 yuan per mu.

The reason why the excess concentrated saline-alkali water is directly recharged is that it has not been used for aquaculture, but is merely concentrated from the original saline-alkali water, and no additional exogenous substances, such as bacteria, are introduced. Therefore, direct recharge is safe and reliable.

When the saline-alkali water is extracted as underground saline-alkali water, the recharge position of the concentrated saline-alkali water is at the bottom of the buried aquifer. When the saline-alkali water is extracted as surface saline-alkali water, the recharge position of the concentrated saline-alkali water is at the bottom of the surface saline-alkali water body. Different recharge positions of the concentrated saline-alkali water result in different effects on the salinity of saline-alkali water at various depths. Taking surface saline-alkali water from Alar City as an example, the major ion indices of the original surface saline-alkali water samples are shown in Table 3.

TABLE 3
Major ion indices of surface saline-alkali water after desalination
and salt redistribution (concentration unit: mg/L)

| | Na⁺ | K⁺ | Ca²⁺ | Mg²⁺ | Cl⁻ | SO₄²⁻ |
|---|---|---|---|---|---|---|
| Saline-alkali water at 50 cm below the | 4777.1 | 27.1 | 784.5 | 558.4 | 6833.2 | 3943.1 |
| water surface | | | | | | |
| Reverse osmosis permeates from | 63.2 | 0.0 | 0.0 | 0.0 | 97.6 | 0.0 |
| saline-alkali water | | | | | | |
| Associated concentrated saline-alkali | 6736.2 | 38.7 | 1121.1 | 798.0 | 9625.2 | 5634.7 |
| water from reverse osmosis | | | | | | |
| Saline-alkali water at the bottom before | 4779.8 | 27.5 | 786.4 | 557.7 | 6835.4 | 3946.7 |
| bottom recharge | | | | | | |
| Saline-alkali water at the bottom after | 5948.0 | 34.2 | 980.4 | 696.3 | 8521.7 | 4953.5 |
| bottom recharge | | | | | | |
| Saline-alkali water at 50 cm below the | 4776.3 | 27.2 | 784.8 | 559.1 | 6834.4 | 3942.7 |
| water surface after bottom recharge | | | | | | |
| Saline-alkali water at 50 cm | 5364.6 | 30.8 | 884.6 | 631.2 | 7672.2 | 4451.2 |
| below the water surface after surface | | | | | | |
| recharge | | | | | | |
| Saline-alkali water at the bottom after | 6007.8 | 34.7 | 990.3 | 703.4 | 8606.5 | 5003.4 |
| surface recharge | | | | | | |

Saline-alkali water at 50 cm below the water surface is extracted. The saline-alkali water is subjected to microfiltration to remove particulate matter, and then desalinated using a reverse osmosis membrane system. Reverse osmosis permeate (the quality of which meets the Class III standard of GB/T 14848-2017) and associated concentrated saline-alkali water are obtained, with a recovery rate of approximately 30%. The water quality indices are stable, as shown in Table 3. The associated concentrated saline-alkali water from the desalination process is transported to the bottom for recharge, and 200 tons of concentrated saline-alkali water is recharged at the bottom each day. After 30 days of bottom recharge, the major ion indices of the saline-alkali water at 50 cm below the bottom recharge outlet and at 50 cm below the water surface are shown in Table 3. Subsequently, the concentrated saline-alkali water is recharged at the water surface. The recharge position is located 30 m south of the extraction outlet, with the recharge pipe opening directed downward. After 5 days of surface recharge, the major ion indices of the saline-alkali water at 50 cm below the recharge pipe opening and at the bottom are shown in Table 3.

In crop planting, water-saving measures such as drip irrigation under mulch are adopted. In arid regions, where the average annual evaporation is 2-3 m, the use of mulch technology saves 1,250-1,950 tons of fresh water per mu. When combined with drip irrigation technology, a personalized fresh water supply is provided to crops, addressing the shortage of fresh water resources and potentially alleviating or even resolving the issue of groundwater level decline.

The conventional concept of mulching is to maintain temperature within the mulch and reduce evaporation, thereby decreasing water consumption. The present disclosure differs from this conventional concept of mulching. The purpose of reducing water consumption in the present disclosure is to maintain the stability of the groundwater level without altering the original hydrogeological conditions. Unlike conventional approaches, which may lead to groundwater level decline or even ground collapse, the method of the present disclosure represents a green and sustainable development approach.

The drainage or tailwater generated from aquaculture (i.e., the aquaculture water remaining after harvesting aquatic products) is subjected to solid-liquid separation. Solid organic matter, such as feces and residual bait, is used as organic fertilizer for crop growth. The filtered aquaculture water or tailwater is either recycled for aquaculture or directed into the outer pond excavated in step S1. Evaporation from the outer pond also increases the water vapor content in the local air, and salt-tolerant plants and animals are cultivated in the outer pond. The tailwater in the present disclosure is not directly recharged into groundwater. The reason is that the tailwater contains exogenous substances such as bacteria, which differ from those in the original groundwater, and direct recharge may cause groundwater pollution. After being filtered through sand and gravel, the water in the outer pond is used to replenish the groundwater level or is separated by a waterproof layer, with salt being precipitated as salinity increases, and is subsequently used for the preparation and sale of industrial salt.

Step S5, photovoltaic power generation.

The present disclosure further provides a photovoltaic power generation module, which is configured for saline-alkali water desalination, crop planting, and aquaculture for aquatic products. Through the arrangement of a photovoltaic power generation module, the whole system can meet the self-sufficiency of electricity, without access to external power.

Additionally, the energy in the whole system basically achieves the circulation, and the saline-alkali water and fresh water in the system also achieve the circulation, which is conducive to the stability of the local ecology and the development of the region.

### Embodiment 2

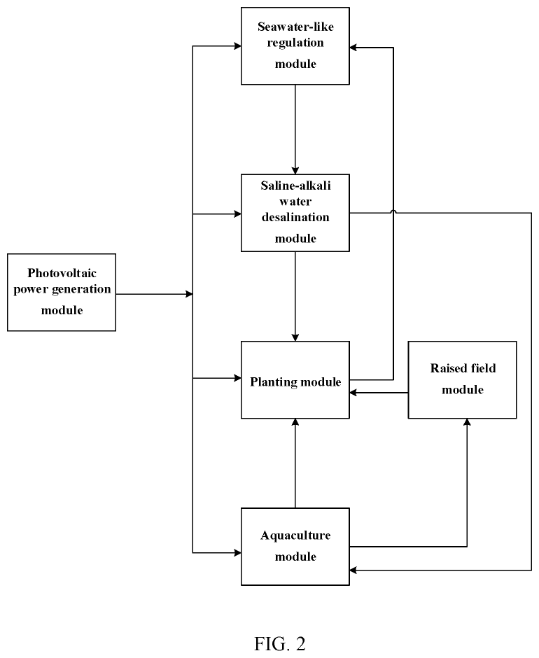

As shown in FIG. 2, the present disclosure further provides a multi-stage circular agricultural system and method for saline-alkali land based on multi-stage resource utilization of saline-alkali water, including a seawater-like regulation module, a saline-alkali water desalination module, a planting module, an aquaculture module, a raised field module, and a photovoltaic power generation module;
wherein the seawater-like regulation module is configured to adjust the underground saline-alkali water into saline-alkali water having an ion composition and content similar to or consistent with that of both aquaculture water and seawater of the same salinity.

The saline-alkali water desalination module is configured to desalinate the adjusted saline-alkali water through the reverse osmosis system, thereby obtaining fresh water and seawater-like water simultaneously.

The planting module is configured to cultivate crops suitable for the local environment, and may be equipped with a corresponding drip irrigation system under mulch or water anti-evaporation technology.

The aquaculture module is configured to cultivate aquatic products suitable for seawater-like water. Fresh water is configured to be used for the planting module, or for cultivating freshwater aquatic products, or is first configured to be used for cultivating freshwater aquatic products, after which the tailwater is configured to be used for the planting module.

The raised field module is configured to increase the distance between surface soil and groundwater level, and to form an outer pond and/or reservoir.

The photovoltaic power generation module is configured to supply power to the seawater-like regulation module, the saline-alkali water desalination module, the planting module, and the aquaculture module.

### Embodiment 3

The experimental site is located at a base 4 km from the K104 section of Tazhong No. 1 Highway in the 14th Regiment, Alar City, on the northern margin of the Taklimakan Desert. This site exhibits typical desert saline-alkali land characteristics, including a high underground saline-alkali water level (with a salinity of 9‰), white saline-alkali crystals covering the surface, and extremely sparse vegetation. On Apr. 7, 2025, a 1.2-mu experimental field is leveled using an excavator. Starting from April 8, the fresh water prepared according to Embodiment 1 is used for flood irrigation for salt leaching, with a total irrigation volume of 166 m³. After the saline water is fully infiltrated, comprehensive field preparation is performed on April 14, including the application of base fertilizer, rotary tillage and soil loosening, land leveling, laying the drip irrigation hose, and covering with plastic mulch. Simultaneously, sowing and transplanting are completed: seeds of the Heilongjiang soybean variety ‘Heihe 35’, as well as local peanut, cotton, and corn seeds, are sown using a portable on-demand seeder, and local sweet potato seedlings are transplanted. And the conventional planting management is performed.

### The Planting Results Show the Following:

May 4: The overall emergence rate of all seed types reaches 70%.

May 26: Observations indicate that soybean plants reach a height of approximately 20 cm and enter the flowering-podding stage. Some soybean plants that emerged and progressed earlier through their growth cycle are observed to have pods. Peanut plants reach a height of approximately 10 cm (with partial flowering), cotton plants reach a height of approximately 15 cm, corn plants reach a height of approximately 50 cm, and sweet potato plants reach a height of approximately 10 cm.

June 4: Soybean plant height increases to approximately 40 cm, and those that have already formed pods are entering the pod-filling stage, with the soybeans gradually becoming plump; a large number of flowers have set pods, and the plants are currently in full bloom. Peanut plant height reaches approximately 12 cm, with an increased proportion of flowering. Cotton plant height reaches approximately 20 cm; corn plant height reaches approximately 80 cm; sweet potato plant height reaches approximately 15 cm. All crops are growing well overall.

June 9: Soybean plant height increases to approximately 55 cm, and the soybeans are becoming increasingly plump (when the pods are split, the soybeans inside appear quite plump); all the early-flowering plants have set pods, and the later-flowering plants are also beginning to enter the flowering-podding stage. Peanut plant height reaches approximately 14 cm, with an increased proportion of flowering. Cotton plant height reaches approximately 30 cm; corn plant height reaches approximately 120 cm; sweet potato plant height reaches approximately 20 cm. All crops are growing well overall.

The Above Results Fully Prove that:

Active improvement of saline-alkali land: the fresh water produced by the present disclosure is used for flood irrigation for salt leaching, whereby severely saline-alkali land is effectively converted into cultivated land suitable for the growth of conventional crops.

Normal crop growth performance: the tested crops (including non-salt-tolerant varieties such as Heihe 35 soybean) not only emerge successfully, but also complete their normal growth and development cycles, including vegetative growth, flowering, and fruiting.

The technology is universally applicable: this technology does not rely on the screening or development of specific salt-tolerant germplasm, and is universally applicable to conventional crops.

Excellent timeliness of improvement: after salt leaching is performed using the fresh water of the present disclosure, crop planting and harvesting are achieved within the same year, thereby significantly shortening the improvement cycle of saline-alkali land.

It should be noted that any details not explicitly described in the present disclosure are considered to be in the prior art and are well known to those skilled in the art. It is not necessary to reduce the concentration of potassium ions and/or magnesium ions if such concentrations are higher than those of seawater of the same salinity before treatment with the reverse osmosis system. During reverse osmosis system treatment, as long as fouling of the reverse osmosis membrane is avoided, the method used in the present disclosure is applicable even when the seawater-like water salinity exceeds 35‰, or the fresh water yield exceeds 50%. In situations where groundwater level or surface evaporation is controlled, saline-alkali land reclamation is also achieved without the use of raised fields. Before using the fresh water for irrigation, it may be employed for freshwater aquaculture first; the aquaculture tailwater from this process may be used for cultivation. This not only boosts economic benefits but also fertilizes the field and reduces alkalinity. Because photovoltaic power generation is used not only to supply power to modules such as the saline-alkali water desalination module, but also to generate profit through grid connection, the simplest configuration, including the photovoltaic module, the saline-alkali water desalination and recharge module, and the planting module, may be selected, and the sustainable development of saline-alkali land or desert farmland is achieved through “supporting agriculture through energy,” thereby achieving the purpose of rapid and large-scale utilization and reclamation for saline-alkali land or desert reclamation.

Therefore, the present disclosure adopts the above-described multi-stage circular agricultural system and method for saline-alkali land based on multi-stage resource utilization of saline-alkali water, i.e., a multi-stage circular agricultural system for saline-alkali land is constructed based on multi-stage resource utilization of saline-alkali water. The entire system is self-contained and does not require an external supply of fresh water or an external power supply. A win-win scenario among ecological benefits, social benefits, and economic benefits is achieved, green and sustainable development is achieved, thus holding universal applicability for the comprehensive development and utilization of saline-alkali land.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A multi-stage circular agricultural method for saline-alkali land based on multi-stage resource utilization of saline-alkali water, comprising the following steps:
step S1, after detecting saline-alkali water in a saline-alkali area, extracting the saline-alkali water for seawater-like regulation, that is, adjusting ion composition and proportion of the saline-alkali water according to requirements of aquaculture water for aquatic products, and obtaining adjusted saline-alkali water;
step S2, desalinating the adjusted saline-alkali water through a first-stage reverse osmosis system to obtain both fresh water and seawater-like water;
step S3, employing the obtained fresh water for crop cultivation, and employing the obtained seawater-like water for aquaculture; and
step S4: after harvesting aquatic products, performing a solid-liquid separation on aquaculture tailwater, utilizing filtered residues as a fertilizer for crop planting, and discharging filtered tailwater into an outer pond or recycling it for aquaculture;
wherein in step S1, the saline-alkali water is regulated by a seawater-like regulation method to obtain the regulated saline-alkali water, comprising the following two situations:
situation 1: when a calcium hardness of the extracted saline-alkali water is greater than that of the aquaculture water for aquatic products, a calcium ion concentration to be removed is determined based on an original calcium ion concentration of the saline-alkali water and concentrations of calcium ions, potassium ions, and magnesium ions in the intended aquaculture water after adjustment, then, calcium ions are removed, while potassium ions and magnesium ions are supplemented;
a method for removing calcium ion concentration is: adding potassium oxalate or sodium oxalate to the water to precipitate calcium ions;
situation 2: when the calcium hardness of the extracted saline-alkali water is less than that of the aquaculture water for aquatic products, calcium ions, potassium ions, and magnesium ions are supplemented to the saline-alkali water based on concentrations of calcium ions, potassium ions, and magnesium ions in the intended aquaculture water after adjustment;
wherein in step S3, when a quantity of seawater-like water meets requirements for aquaculture, the remaining saline-alkali water is directly subjected to a desalination treatment without undergoing seawater-like regulation, and the resulting concentrated saline-alkali water is directly recharged to a bottom of the saline-alkali water layer.

2. The multi-stage circular agricultural method for saline-alkali land based on multi-stage resource utilization of saline-alkali water according to claim 1, wherein in step S2, a freshwater yield obtained by the reverse osmosis system is 45-50%.

3. The multi-stage circular agricultural method for saline-alkali land based on multi-stage resource utilization of saline-alkali water according to claim 1, wherein in step S2, a salinity of the the seawater-like water obtained by the reverse osmosis system is less than or equal to 35‰.

4. A multi-stage circular agricultural system for saline-alkali land based on multi-stage resource utilization of saline-alkali water, to implement the multi-stage circular agricultural method for saline-alkali land based on multi-stage resource utilization of saline-alkali water according to claim 1, comprising:
a seawater-like regulation module, configured to adjust saline-alkali water into saline-alkali water having an ion composition and content similar to or consistent with that of both aquaculture water and seawater of the same salinity;
a saline-alkali water desalination module, configured to desalinate the adjusted saline-alkali water through a reverse osmosis system, thereby obtaining fresh water and seawater-like water simultaneously;
a planting module, comprising a drip irrigation system under mulch;
an aquaculture module, configured for aquaculture of aquatic products;
a raised field module, configured to increase a distance between surface soil and a groundwater level, and to form an outer pond and/or reservoir; and
a photovoltaic power generation module, configured to supply power to the seawater-like regulation module, the saline-alkali water desalination module, the planting module, and the aquaculture module.
